(19) United States
(12) Patent Application Publication
(10) Pub. No.: US 2009/0068317 A1
(43) Pub. Date: Mar. 12, 2009

(54) Ice Cream toppers

(76) Inventors: Margaret Sue Mah, Lees Summit, MO (US); Karen Sue West, Lees Summit, MO (US)

Correspondence Address: Margaret Sue Mah;Karen Sue West, 5035 SW Widgeon Way, Lees Summit, MO, 64082, US

(21) Appl. No.: 11/900,425

(22) Filed: Sep. 12, 2007

(51) Int. Cl. B65D 85/00; A23G 3/36

(52) U.S. Cl. 426/93; 426/115; 426/394

(57) ABSTRACT

A clear description of the Invention would be that it is a ready to eat, blend of edible food products to be dispensed on Ice Cream.

This Invention solves the present problem in the retail consumer market for a packaged, non-frozen mixture of edible toppings which the retail costumer may purchase to self-flavor Ice Cream.

Products presently available to the independent consumer are mostly syrups and chocolate coatings, none having the diverse assortment of ingredients and flavors which this invention will make available.

The best mode of this invention would include the mixing, by machine or manually, with or without stirring, of food products, either whole or ground, to be packaged in a container or flexible wrapper having diverse utility.

The result of this Invention would be a product readily available to the consumer who wishes self-flavor their Ice Cream.

### BACKGROUND OF THE INVENTION

This Invention fills a void in the retail consumer market for a packaged, non-frozen mixture of edible toppings which the retail costumer may purchase to self-flavor Ice Cream.

Products presently available to the independent consumer are mostly syrups and chocolate coatings, none having the diverse assortment of ingredients and flavors which this invention will make available.

### BRIEF SUMMARY OF THE INVENTION

This Invention constitutes a packaged, non-frozen mixture of Toppings capable of storage at ambient temperature, and immediate use after storage, comprising

broadly a plurality of edible mixed toppings to be dispensed on Ice Cream.

1. A packaged, non-frozen blend of edible toppings capable of storage at ambient temperature, easily dispensed from container or flexible wrapper onto Ice Cream.

2. A number of illustrative embodiments of claim 1 are described below. These embodiments are intended to provide useful and illustrative examples of the Ice Cream Toppers composition, and to assist one of ordinary skill in making and using the same, and are not intended to limit the scope of the invention.

3. The food product of claim 1, wherein the blend may be comprised of:
Candied fruit; Candied fruit snacks; Candied nuts; Crystallized fruit; Cut fruits; Dehydrated fruit snacks; Dried fruit mixes; Dried fruits; Fruit and soy based snack food; Fruit chips; Fruit topping; Fruit-based organic food bars; Fruit-based snack food; Nut butters; Nut meats; Nut topping; Organic nut and seed-based snack bars; Peanut butter toppings; Pickled fruits; Processed fruit- and nut-based food bars; Processed fruits; Processed nuts; Processed pignoli pine nuts; Processed vegetables and fruits; Roasted nuts; Shelled nuts; Sliced fruits; Snack mix consisting primarily of processed fruits, processed nuts and/or raisins.

3. The food product of claim 1, wherein the blend may be comprised of:
Candies; Candy; Candy bars; Candy mints; Candy with caramel; Candy with cocoa; Chocolate candies; Chocolate covered nuts; Chocolate topping; Cookies; Food package combinations consisting primarily of bread, crackers and/or cookies; Fruit flavorings, except essences; Gummy candies; Peppermint candy; Snack mix consisting primarily of crackers, pretzels, candied nuts and/or popped popcorn; Starch-based candies; Sugarless candies

4. The food product of claim 1, wherein the blend could be used as:
An ingredient in many baking and cooking applications such as, cakes, pies, brownies, cupcakes, cobblers, shakes, malts, puddings, cookies, breads and the like.

5. The food product of claim 1, wherein the blending process includes the mixing, by machine or manually, with or without stirring, of food products, either whole or ground, to be packaged in a container or flexible wrapper having diverse utility.
